(19) United States
(12) Patent Application Publication
(10) Pub. No.: US 2015/0352832 A1
(43) Pub. Date: Dec. 10, 2015

(54) LIQUID TRANSFER DEVICE

(71) Applicant: KOMORI CORPORATION, Sumida-ku, Tokyo (JP)

(72) Inventors: Hiroyoshi KAMODA, Tsukuba-shi (JP); Akehiro KUSAKA, Tsukuba-shi (JP)

(73) Assignee: KOMORI CORPORATION, Tokyo (JP)

(21) Appl. No.: 14/764,907

(22) PCT Filed: Jan. 20, 2014
(86) PCT No.: PCT/JP2014/050895

§ 371 Date: Jul. 30, 2015

(30) Foreign Application Priority Data
Jan. 31, 2013 (JP) 2013-016436
Jan. 31, 2013 (JP) 2013-016437
Jan. 31, 2013 (JP) 2013-016438

(51) Int. Cl. B41F 16/00

(52) U.S. Cl. CPC B41F 16/00

(57) ABSTRACT

A coater (100), which is capable of spot coating a layer thick enough to be palpable onto a transfer object, is provided with a first coating unit (120) and a second coating unit (130). The first coating unit (120) is provided with a first impression cylinder (121) and a rotary screen cylinder (122) for transferring a first varnish on one surface of a sheet (1). The second coating unit (130) is provided with a second impression cylinder (131) and a cylinder (132) for transferring a second varnish on the first varnish that has been transferred onto the one surface of the sheet. Palpable protrusions formed by transfer of the first varnish in the first coating unit (120) are covered by the second varnish in the second coating unit (130) while maintaining the shapes thereof.

### TECHNICAL FIELD

The present invention relates to a liquid transfer device configured to transfer a liquid to a substrate, and particularly relates to a device which is effective when being applied to a coater for applying a coating to a sheet.

### BACKGROUND ART

As a coating device for applying a coating to a sheet, there has been known an apparatus disclosed in Patent Document 1 listed below, for example. The coating device disclosed in Patent Document 1 is capable of applying a spot coating to only a certain area of a sheet with a lacquer by way of a flexographic printing press in which the lacquer is supplied from a chamber doctor to an applicator roller, and thereafter applying a full-surface coating to the sheet with a lacquer by way of a lacquering unit in which the lacquer is stored between a metering roller and an applicator roller.

### CITATION LIST

### Patent Literature

Patent Literature 1: Japanese Patent Application Publication No. H06-320712
Patent Literature 2: Japanese Patent Application Publication No. 2007-237537

### SUMMARY OF INVENTION

### Technical Problem

By performing the foregoing spot coating and full-surface coating, the coating device described in Patent Document 1 listed above is capable of providing a coating which produces a visual difference between the spot-coated areas and the other area, and further capable of providing a tactile coating, more specifically, a coating which makes the spot-coated areas and the other area give different tactile feelings when being touched by a finger. Thus, the coating device can provide a coating not only producing a visual effect but also achieving a higher added value. For example, a coating may be used for conveying information to visually impaired people or any other purposes. In this way, the application range can be expanded, and therefore the market can be widened.

In this regard, in order to surely apply such a tactile coating, a thick spot coating needs to be applied, that is, a thick layer of a coating liquid needs to be applied by spot coating. However, the conventional device described in Patent Document 1 listed above is capable of using only lacquers with low viscosity, and therefore has difficultly in applying a spot coating with a layer thick enough to give an adequately tactile feeling.

Such a problem is not exclusive to a case where a coating is applied to a sheet. In any case where a liquid is transferred to a substrate of any kind including a web or the like, such a problem may also occur as similar to the case described above.

Under these circumstances, the present invention has an objective to provide a liquid transfer device capable of spot coating a substrate with a thick layer.

### Solution to Problem

In order to solve the foregoing problems, a liquid transfer device according to a first aspect of the invention comprises: first liquid transfer means configured to transfer a first liquid to one side of a substrate in such a manner that the first liquid forms a tactile raised part on the one side of the substrate; and second liquid transfer means provided downstream of the first liquid transfer means in a substrate carrying direction, and configured to transfer a second liquid to the one side of the substrate in such a manner that the second liquid covers the raised part while maintaining a shape of the raised part on the one side of the substrate.

A liquid transfer device according to a second aspect of the invention is the liquid transfer device according to the first aspect of the invention in which: the first liquid transfer means is a first coating unit including a first support cylinder configured to hold and carry the substrate, and a rotary screen cylinder provided in contact with the first support cylinder, and configured to coat the one side of the substrate with the first liquid while the substrate is passing between the first support cylinder and the rotary screen cylinder; and the second liquid transfer means is a second coating unit including a second support cylinder configured to hold and carry the substrate in such a manner as to bring an outer circumferential surface of the second support cylinder into contact with an opposite side of the substrate, a coater cylinder provided in contact with the second support cylinder, and coater cylinder liquid supply means configured to supply the second liquid to the coater cylinder, the second coating unit configured to coat the one side of the substrate with the second liquid.

A liquid transfer device according to a third aspect of the invention is the liquid transfer device according to the second aspect of the invention in which the substrate is a sheet, the first support cylinder of the first coating unit is a first impression cylinder configured to hold and carry the sheet, the second support cylinder of the second coating unit is a second impression cylinder configured to hold and carry the sheet, the liquid transfer device further comprises: upstream sheet carrying means provided upstream of the first impression cylinder of the first coating unit in a sheet carrying direction, and configured to carry the sheet to the first impression cylinder; intermediate sheet carrying means provided downstream of the first impression cylinder of the first coating unit in the sheet carrying direction, and upstream of the second impression cylinder of the second coating unit in the sheet carrying direction, and configured to carry the sheet received from the first impression cylinder to the second impression cylinder; and downstream sheet carrying means provided downstream of the second impression cylinder of the second coating unit in the sheet carrying direction, and configured to carry the sheet received from the second impression cylinder, the rotary screen cylinder of the first coating unit is in contact with the first impression cylinder between a reception position at which the first impression cylinder receives the sheet from the upstream sheet carrying means, and a transfer position at which the first impression cylinder transfers the sheet to the intermediate sheet carrying means, and the coater cylinder of the second coating unit is in contact with the second impression cylinder at a position below an axial center position of the second impression cylinder and between a reception position at which the second impression cylinder receives the sheet from the intermediate sheet carrying means and a transfer position at which the second impression cylinder transfers the sheet to the downstream sheet carrying means.

A liquid transfer device according to a fourth aspect of the invention is the liquid transfer device according to the second or third aspect of the invention in which the coater cylinder liquid supply means of the second coating unit includes an anilox roller provided in contact with the coater cylinder, and a chamber configured to supply the second liquid to the anilox roller.

A liquid transfer device according to a fifth aspect of the invention is the liquid transfer device according to the second or third aspect of the invention in which the coater cylinder liquid supply means of the second coating unit includes a liquid pool in which the second liquid is stored, a form roller provided in contact with the coater cylinder, a metering roller provided in contact with the form roller, and a dampening roller provided in contact with the metering roller and configured to pick up the second liquid inside the liquid pool.

A liquid transfer device according to a sixth aspect of the invention is the liquid transfer device according to the first aspect of the invention in which the first liquid is a transparent ink, the second liquid is a varnish, the first liquid transfer means is a first coating unit including an ink fountain in which the transparent ink is stored, a fountain roller configured to pick up the transparent ink inside the ink fountain, an oscillating roller provided in contact with the fountain roller, a form roller provided in contact with the fountain roller or the oscillating roller, a plate cylinder provided in contact with the form roller, and a first support cylinder provided in contact with the plate cylinder, and configured to hold and carry the substrate, the first coating unit configured to coat the one side of the substrate with the transparent ink, and the second liquid transfer means is a second coating unit including a second support cylinder configured to hold and carry the substrate in such a manner as to be in contact with an opposite side of the substrate, a coater cylinder provided in contact with the second support cylinder, and varnish supply means configured to supply the varnish to the coater cylinder, the second coating unit configured to coat the one side of the substrate with the varnish.

A liquid transfer device according to a seventh aspect of the invention is the liquid transfer device according to the sixth aspect of the invention in which the plate cylinder of the first coating unit is in contact with the first support cylinder at a position below an axial center position of the first support cylinder, and the coater cylinder of the second coating unit is in contact with the second support cylinder at a position below an axial center position of the second support cylinder.

A liquid transfer device according to an eighth aspect of the invention is the liquid transfer device according to the seventh aspect of the invention in which the substrate is a sheet, the first support cylinder of the first coating unit is a first impression cylinder configured to hold and carry the sheet, the second support cylinder of the second coating unit is a second impression cylinder configured to hold and carry the sheet, the liquid transfer device comprises: upstream sheet carrying means provided upstream of the first impression cylinder of the first coating unit in a sheet carrying direction, and configured to carry the sheet to the first impression cylinder; intermediate sheet carrying means provided downstream of the first impression cylinder of the first coating unit in the sheet carrying direction and upstream of the second impression cylinder of the second coating unit in the sheet carrying direction, and configured to carry the sheet received from the first impression cylinder to the second impression cylinder; and downstream sheet carrying means provided downstream of the second impression cylinder of the second coating unit in the sheet carrying direction, and configured to carry the sheet received from the second impression cylinder, the plate cylinder of the first coating unit is in contact with the first impression cylinder between a reception position at which the first impression cylinder receives the sheet from the upstream sheet carrying means, and a transfer position at which the first impression cylinder transfers the sheet to the intermediate sheet carrying means, and the coater cylinder of the second coating unit is in contact with the second impression cylinder between a reception position at which the second impression cylinder receives the sheet from the intermediate sheet carrying means, and a transfer position at which the second impression cylinder transfers the sheet to the downstream sheet carrying means.

A liquid transfer device according to a ninth aspect of the invention is the liquid transfer device according to the eighth aspect of the invention in which the downstream sheet carrying means includes an endless chain arranged in such a circular manner as to circularly run between a reception position at which the endless chain receives the sheet from the second impression cylinder of the second coating unit and a distant position at which the endless chain is located away from the second impression cylinder, the endless chain directed in such a manner as to run on an upper side from the reception position to the distant position, and to run on a lower side from the distant position to the reception position; and a claw hook attached to the endless chain in such a manner as to move along with running of the endless chain, and configured to receive and hold the sheet from the second impression cylinder of the second coating unit, and the liquid transfer device comprises: varnish drying means configured to dry the varnish on the one side of the sheet held by the claw hook which is running and moving on the upper side of the endless chain; and sheet stacking means provided below the endless chain and configured to stack the sheet released from the claw hook.

A liquid transfer device according to a tenth aspect of the invention is the liquid transfer device according to any one of the sixth to ninth aspects of the invention in which the varnish supply means of the second coating unit includes an anilox roller provided in contact with the coater cylinder, and a chamber configured to supply the varnish to the anilox roller.

A liquid transfer device according to an eleventh aspect of the invention is the liquid transfer device according to any one of the sixth to ninth aspects of the invention in which the varnish supply means of the second coating unit includes a liquid pool in which the varnish is stored, a form roller provided in contact with the coater cylinder, a metering roller provided in contact with the form roller, and a dampening roller provided in contact with the metering roller and configured to pick up the varnish inside the liquid pool.

Meanwhile, a liquid transfer method according to a twelfth aspect of the invention comprises: transferring a first liquid to one side of a substrate in such a manner that the first liquid forms a tactile raised part on the one side of the substrate; and thereafter transferring a second liquid to the one side of the substrate in such a manner that the second liquid covers the raised part while maintaining a shape of the raised part on the one side of the substrate.

Furthermore, a substrate according to a thirteenth aspect of the invention comprises: a tactile raised part formed on one side of the substrate by transferring a first liquid to the one side; and a coating part formed on the one side by transferring a second liquid to the one side in such a manner that the second liquid covers the raised part while maintaining a shape of the raised part.

### Advantageous Effects of Invention

With the liquid transfer device according to the present invention, the first liquid transfer means transfers the first liquid to one side of a substrate so as to form a tactile raised part on the one side of the substrate, and thereafter the second liquid transfer means transfers the second liquid to the one side of the substrate so as to form a coating part covering the raised part while maintaining a shape of the raised part on the one side of the substrate. Thus, an adequately tactile coating can be easily applied to a substrate. In addition, since the raised part of the first liquid formed on the substrate can be covered with the coating part of the second liquid, the raised part can be prevented from dropping off from the substrate.

### BRIEF DESCRIPTION OF DRAWINGS

FIG. 1 is a schematic structural diagram of a first embodiment in which a liquid transfer device according to the present invention is applied to a coater.

FIG. 2 is a schematic structural diagram of an important section of a first coating unit of the coater in FIG. 1.

FIG. 3 is a cross sectional view of a sheet processed by the coater in FIG. 1

FIG. 4 is a schematic structural diagram of a second embodiment in which a liquid transfer device according to the present invention is applied to a coater.

FIG. 5 is a schematic structural diagram of a third embodiment in which a liquid transfer device according to the present invention is applied to a coater.

FIG. 6 is a schematic structural diagram of an important section of a first coating unit of the coater in FIG. 5.

FIG. 7 is an enlarged view of an extracted section indicated by an arrow line VII in FIG. 6.

FIG. 8 is an enlarged view of an extracted section indicated by an arrow line VIII in FIG. 6.

FIG. 9 is a schematic structural diagram of a fourth embodiment in which a liquid transfer device according to the present invention is applied to a coater.

FIG. 10 is a schematic structural diagram of a fifth embodiment in which a liquid transfer device according to the present invention is applied to a coater.

FIG. 11 is a schematic structural diagram of a sixth embodiment in which a liquid transfer device according to the present invention is applied to a coater.

FIG. 12 is a schematic structural diagram of an important section of another embodiment in which a liquid transfer device according to the present invention is applied to a coater.

FIG. 13 is a cross sectional view of another example of a processed sheet.

### DESCRIPTION OF EMBODIMENTS

Embodiments of a liquid transfer device according to the present invention are described based on the drawings. The present invention, however, is not limited only to the embodiments described below based on the drawings.

### First Embodiment

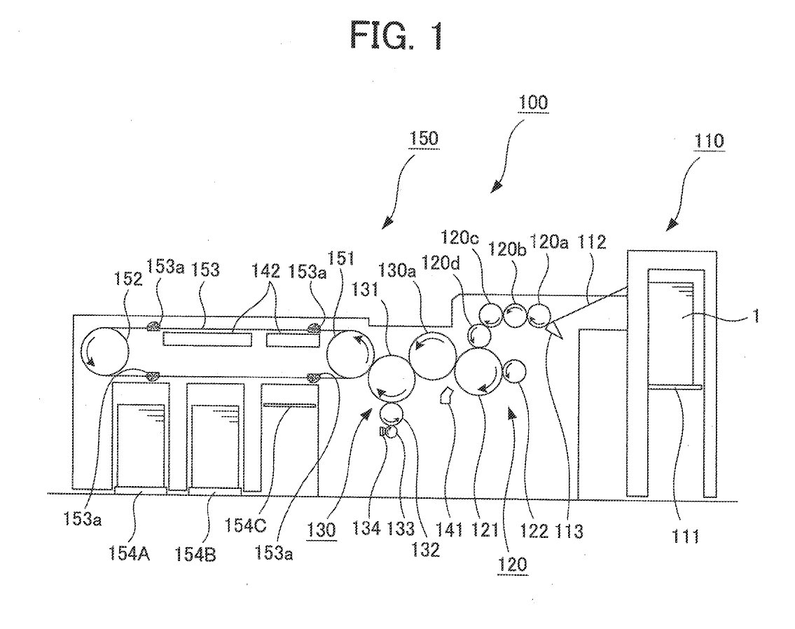

A first embodiment in which a liquid transfer device according to the present invention is applied to a coater is described below based on FIGS. 1 to 3.

As illustrated in FIG. 1, a transfer cylinder 120a configured to hold and carry a sheet 1 is provided at a tip end side of a feeder board 112 of a paper feeder 110 as a sheet feeder unit configured to send out and feed one by one sheets 1, as substrates, which are placed on a paper feed tray 111. The transfer cylinder 120a is configured to be able to receive the sheets 1 one by one from the aforementioned feeder board 112 via a swing device 113. A transfer cylinder 120b configured to hold and carry each sheet 1 is in contact with the transfer cylinder 120a. A transfer cylinder 120c configured to hold and carry the sheet 1 is in contact with the transfer cylinder 120b. A transfer cylinder 120d configured to hold and carry the sheet 1 is in contact with the transfer cylinder 120c.

A first impression cylinder 121, which is a first support cylinder of a first coating unit 120 as first liquid transfer means, is in contact with a lower side of the transfer cylinder 120d. To put it another way, the transfer cylinder 120d is located at an upper side of the first impression cylinder 121 while being in contact with the first impression cylinder 121. A rotary screen cylinder 122 is in contact with a lateral side of the first impression cylinder 121, the lateral side being located downstream in a rotation direction (downstream in a carrying direction of the sheet 1) of a contact position of the first impression cylinder 121 with the transfer cylinder 120d, i.e., a reception position at which the first impression cylinder 121 receives the sheet 1 from the transfer cylinder 120d. The rotary screen cylinder 122 is set with its axial center position arranged at substantially the same height level with an axial center position of the first impression cylinder 121.

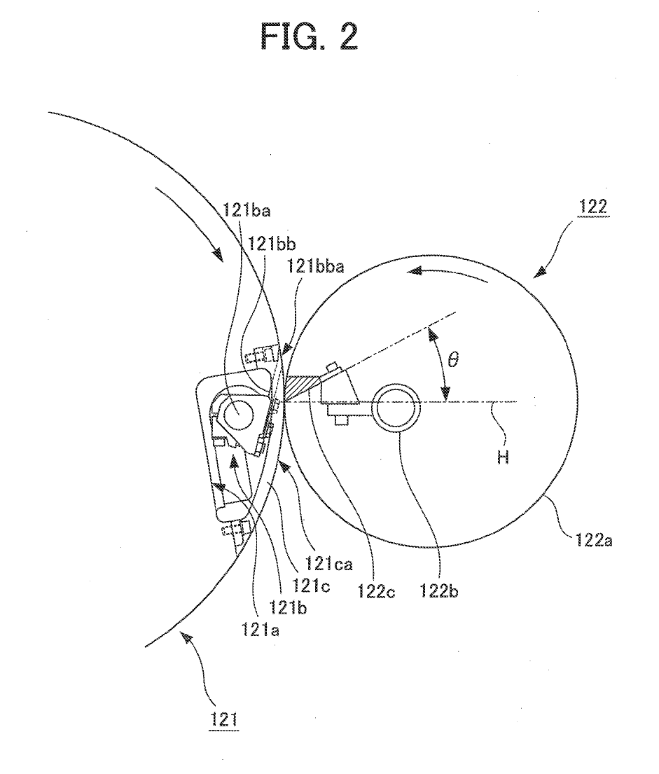

As illustrated in FIG. 2, the rotary screen cylinder 122 is capable of spot-coating an outer side (one side) of the sheet 1 with a first varnish which is a first liquid while the sheet 1 is being carried by the first impression cylinder 121. Here, the sheet 1 transferred from the transfer cylinder 120d is gripped by a gripper device (sheet holder device) 121b of the first impression cylinder 121, and thereby is held on an outer circumferential surface of the first impression cylinder 121.

A screen 122a is wound around the rotary screen cylinder 122. The screen 122a is a cylindrical woven mesh in which small openings are formed by etching corresponding to locations to be spot-coated. A squeegee shaft 122b and a squeegee 122c are provided inside the rotary screen cylinder 122. The squeegee shaft 122b is supported at both end sides by a frame so as to be movable in radial directions, and configured to supply the first varnish. The squeegee 122c is configured to supply the first varnish supplied from the squeegee shaft 122b to the impression cylinder 121 side by squeezing the first varnish out of the small openings of the screen 122a. The squeegee 122c and the squeegee shaft 122b constitute a squeegee unit. The squeegee unit is set such that an angle (squeegee installation angle) θ formed between the squeegee 122c and a horizontal plane passing through a tip end portion of the squeegee 122c is 0° or larger (θ≧0°).

A gap guard 121c is provided between one and the other end portions of a cutout portion 121a of the first impression cylinder 121. The gap guard 121c includes a guide surface 121ca having a curvature radius substantially equal to that of an outer circumferential surface of the first impression cylinder 121, and is arranged to cover the cutout portion 121a so as to make the outer circumferential surface of the first impression cylinder 121 a continuous surface.

In addition, the gripper device 121b is provided inside the cutout portion 121a of the first impression cylinder 121, and is capable of holding and releasing the sheet 1 by closing and opening a claw 121bb with turning of a claw shaft 121ba. A guide surface 121bba is formed on an outer side surface of the claw 121bb. The guide surface 121bba has a curvature radius substantially equal to that of the outer circumferential surface of the first impression cylinder 121 so as to continuously connect, at the one end portion of the cutout portion 121a, to the outer circumferential surface of the first impression cylinder 121. This structure is capable of preventing the rotary screen cylinder 122 from falling into the cutout portion 121a or from being dented by the claw 121bb, thereby making the life of the screen 122a longer.

As illustrated in FIG. 1, a transfer cylinder 130a configured to hold and carry the sheet 1 is in contact with the first impression cylinder 121 of the first coating unit 120 at a position downstream in the rotation direction (downstream in the carrying direction of the sheet 1) of the contact position of the first impression cylinder 121 with the rotary screen cylinder 122. A first dryer 141 is provided opposed to the first impression cylinder 121 at a position downstream in the rotation direction (downstream in the carrying direction of the sheet 1) of the contact position of the impression cylinder 121 with the rotary screen cylinder 122, and upstream in the rotation direction (upstream in the carrying direction of the sheet 1) of the contact position of the impression cylinder 121 with the transfer cylinder 130a, i.e., a transfer position at which the impression cylinder 121 transfers the sheet 1 to the transfer cylinder 130a. The first dryer 141 is first drying means for drying (curing) the first varnish applied by spot-coating on the coating side (one side) of the sheet 1 by the rotary screen cylinder 122.

A second impression cylinder 131, which is a second support cylinder of a second coating unit 130 as second liquid transfer means, is in contact with the transfer cylinder 130a. A coater cylinder 132 is in contact with the second impression cylinder 131 at a position below an axial center position of the second impression cylinder 131, and downstream in a rotation direction (downstream in the carrying direction of the sheet 1) of a contact position of the second impression cylinder 131 with the transfer cylinder 130a, i.e., a reception position at which the second impression cylinder 131 receives the sheet 1 from the transfer cylinder 130a. A rubber blanket is wound around an outer circumferential surface of the coater cylinder 132. An anilox roller 133 is in contact with the coater cylinder 132. Multiple cells having dimple shapes are formed on an outer circumferential surface of the anilox roller 133. A chamber 134 configured to supply a second varnish as a second liquid to the cells of the anilox roller 133 is in contact with the outer circumferential surface of the anilox roller 133.

A delivery cylinder 151 of a delivery device 150 as a sheet delivery unit is in contact with the second impression cylinder 131 of the second coating unit 130 at a position downstream in the rotation direction (downstream in the carrying direction of the sheet 1) of the contact position of the second impression cylinder 131 with the coater cylinder 132. The delivery cylinder 151 is provided with a not-illustrated sprocket coaxially. A delivery chain 153 which is an endless chain is wound around the sprocket. The delivery chain 153 is also wound around a sprocket 152. Multiple claw hooks 153a are attached to the delivery chain 153 at predetermined intervals in a running direction of the delivery chain 153. The claw hooks 153a receive the sheet 1 from the second impression cylinder 131 via the delivery cylinder 151, and hold the sheet 1.

More specifically, the delivery chain 153 is arranged circularly such that the delivery chain 153 can circulate while running in a horizontal direction between a contact position of the delivery cylinder 151 with the second impression cylinder 131, i.e., a reception position at which the delivery cylinder 151 receives the sheet 1 from the second impression cylinder 131, and a position of the sprocket 152, i.e., a distant position away from the second impression cylinder 131. The delivery chain 153 is directed such that the delivery chain 153 on an upper side can run from the reception position to the distant position, whereas the delivery chain 153 on a lower side can run from the distant position to the reception position. Thus, the delivery chain 153 is capable of causing the claw hooks 153 to run and move from the reception position to the distant position on the upper side and to run and move from the distant position to the reception position on the lower side.

Multiple (three in the present embodiment) delivery trays 154A to 154C are provided below the delivery chain 153 and arranged side by side along the running direction of the delivery chain 153. Each of the delivery trays 154A to 154C is sheet stack means for stacking sheets 1 released from the claw hooks 153a. A second dryer 142 is provided between the sprocket 152 and the sprocket provided coaxially with the delivery cylinder 151, in other words, between the upper side and the lower side on which the delivery chain 153 runs. The second dryer 142 is second drying means for drying (curing) a coating of a second varnish applied on the entire surface of the coating side (one side) of the sheet 1 by the second coating unit 130, while the sheet 1 is held by the claw hooks 153a.

In the present embodiment, it should be noted that the transfer cylinders 120a to 120d and others constitute upstream sheet carrying means, the transfer cylinder 130a and others constitute intermediate sheet carrying means, the delivery cylinder 151, the sprocket 152, the delivery chain 153 and others constitute downstream sheet carrying means, and the anilox roller 133, the chamber 134 and others constitute coater cylinder liquid supply means.

Next, description is provided for an operation of a coater 100 according to the present embodiment configured as described above.

Sheets 1 on the paper feed tray 111 are fed one by one by the paper feeder 110. Each of the sheets 1 is transferred by the swing device 113 from the feeder board 112 to the transfer cylinder 120a, and is transferred to the first impression cylinder 121 of the first coating unit 120 via the transfer cylinders 120b to 120d. Then, when the sheet 1 passes between the first impression cylinder 121 and the rotary screen cylinder 122 while being carried and held by the first impression cylinder 121 with one side of the sheet 1 facing outside, a spot-coating of the first varnish is applied to the one side of the sheet 1 at predetermined areas corresponding to the small openings of the screen 122a of the rotary screen cylinder 122. Thereafter, the applied first varnish is dried (cured) by the first dryer 141.

Subsequently, the sheet 1 is transferred from the first impression cylinder 121 of the first coating unit 120 via the transfer cylinder 130a to the second impression cylinder 131 of the second coating unit 130 in such a manner that the opposite side of the sheet 1 comes into contact with the second impression cylinder 131. Then, while the sheet 1 is being carried and held by the second impression cylinder 131 with the one side of the sheet 1 facing outside, the coater cylinder 132 performs coating on the sheet 1 in such a way that the second varnish supplied to the anilox roller 133 from the inside of the doctor chamber 134 is further applied over the entire area of the one side, i.e., in a manner covering the spot-coating of the first varnish applied on the one side.

Then, the sheet 1 is transferred from the second impression cylinder 131 of the second coating unit 130 via the delivery cylinder 151 of the delivery device 150 to the claw hooks 153a of the delivery chain 153. While the sheet 1 is carried to move on the upper side of the delivery chain 153, the second dryer 142 dries (cures) the coating of the second varnish further applied over the entire area of the one side by the second coating unit 130, i.e., in a manner covering the spot-coating of the first varnish applied on the one side. Thereafter, the sheet 1 is carried to turn and move on the lower side of the delivery chain 153, and is released above any of the delivery trays 154A to 154C to be delivered and stacked on the delivery tray 154A to 154C.

Incidentally, the second dryer 142 may be used not only for drying (curing) the second varnish, but also for further drying (curing) the first varnish.

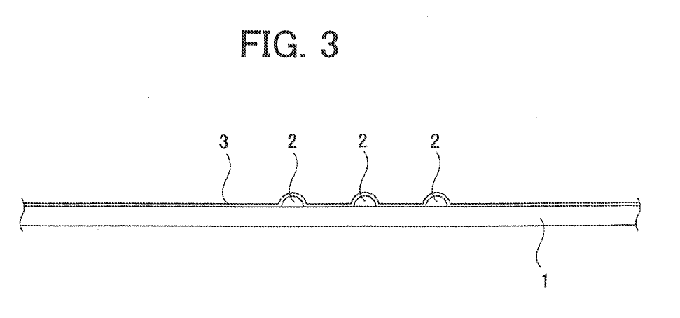

As illustrated in FIG. 3, on the sheet 1 processed by the coater 100 in the foregoing way, tactile raised parts 2 are formed on the one side with the first varnish transferred to the one side, and a coating part 3 covering the raised parts 2 while maintaining shapes of the raised parts 2 is formed on the one side with the second varnish transferred to the one side.

More specifically, the coater 100 according to the present embodiment is configured to transfer the first varnish to the one side of the sheet 1 in such a way that the rotary screen cylinder 122 of the first coating unit 120 forms the tactile raised parts 2 on the one side of the sheet 1 by spot-coating only some areas of the one side of the sheet 1 with the first vanish.

Thus, the coater 100 according to the present embodiment is capable of forming the raised parts 2 by spot-coating the sheet 1 with a thick layer of the first varnish, and therefore is capable of easily applying an adequately tactile coating to the sheet 1.

Hence, according to the present embodiment, it is possible to easily provide the sheet 1 with a visual effect such as a shining effect, and also easily provide the sheet 1 with a tactile effect. Such a coating may be used for a mark or dots allowing a visually impaired person to identify a kind of a banknote, for example, or any other purposes. In this way, the application range can be expanded, and therefore the market can be widened.

In addition, the raised parts 2 (a layer of the first varnish) spot-coated on the one side of the sheet 1 is further coated and covered with the coating part 3 (a layer of the second varnish) by the coater cylinder 132 of the second coating unit 130. Thus, the second varnish can be transferred to the one side of the sheet 1 so as to cover the raised parts 2 while maintaining the shapes of the raised parts 2 on the one side of the sheet 1, in other words, so as to cover the raised parts 2 with the layer having a thickness that allows the shapes of the raised parts 2 to be maintained. In this way, without impairing the tactile effects of the raised parts 2 (the thick layer of the first varnish), it is possible to prevent the raised parts 2 from dropping off from the sheet 1.

Moreover, the coater cylinder 132, the anilox roller 133, and the chamber 134 of the second coating unit 130 are arranged below the axial center position of the second impression cylinder 131. With this structure, various kinds of work, such as manipulation work, cleaning work, component replacement work, and maintenance, for the coater cylinder 132, the anilox roller 133, and the chamber 134 can be performed from a lower side (an installation floor side). This makes it easier to carry out the work, and thereby enables reduction in a burden of an operator. Further, since a space between the installation floor and the transfer cylinder 130a as well as the impression cylinder 131 is also widened, a sufficiently-large working space can be reserved below the transfer cylinder 130a and the impression cylinder 131, so that an operator can easily perform work such as removal of a sheet 1 or a fragment of a sheet 1.

Additionally, the rotary screen cylinder 122 of the first coating unit 120 is arranged in contact with the lateral side of the first impression cylinder 121. In other words, the first impression cylinder 121 is not located below the rotary screen cylinder 122. In this structure, in case the screen 122a of the rotary screen cylinder 122 may be broken during coating due to a certain factor, the first varnish inside the rotary screen cylinder 122 will damage the first impression cylinder 121 and others only to a minimum extent, which may lead to an enhancement of reliability.

Furthermore, the delivery chain 153 of the delivery device 150 is directed such that the delivery chain 153 runs from the reception position to the distant position on the upper side, then turns, and runs from the distant position to the reception position on the lower side. Accordingly, the delivery chain 153 causes the claw hooks 153a to run and move from the reception position to the distant position on the upper side, and to run and move from the distant position to the reception position on the lower side. This enables the following operations: the coating of the varnish applied on the sheet 1 by the second coating unit 130 is dried (cured) by the second dryer 142 while the sheet 1 held by the claw hooks 153a is being carried on the upper side; thereafter the sheet 1 is turned and carried on the lower side; and then the sheet 1 is released from the claw hooks 153a above any of the delivery trays 154A to 154C to be stacked on the delivery tray 154A to 154C. This structure allows the multiple delivery trays 154A to 154C to be installed below the delivery chain 153 over an entire length thereof in the running direction, and enables effective use of an installation space (space saving).

### Second Embodiment

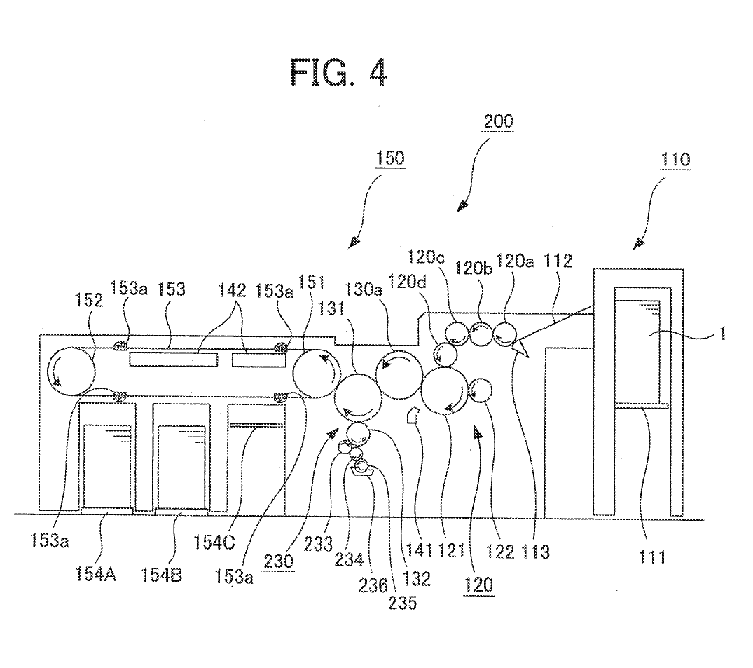

Based on FIG. 4, description is provided for a second embodiment in which a liquid transfer device according to the present invention is applied to a coater. Here, description duplicating the description of the foregoing embodiment is omitted with the same components as those in the foregoing embodiment assigned with the same reference signs as those used in the description of the foregoing embodiment.

As illustrated in FIG. 4, a form roller 233 is in contact with the coater cylinder 132. A metering roller 234 is in contact with the form roller 233. A dampening roller 235 is in contact with the metering roller 234. The dampening roller 235 is located inside a varnish pan 236 as a liquid pool in which the second varnish is stored, and is capable of picking up the second varnish inside the varnish pan 236.

In summary, in a second coating unit 230 of a coater 200 according to the present embodiment, coater cylinder liquid supply means is constituted by the form roller 233, the metering roller 234, the dampening roller 235, the varnish pan 236, and others, instead of the anilox roller 133 and the chamber 134 of the second coating unit 130 of the coater 100 in the foregoing embodiment.

Thus, according to the present embodiment, it is possible to obtain the same effects as those described in the foregoing embodiment.

### Third Embodiment

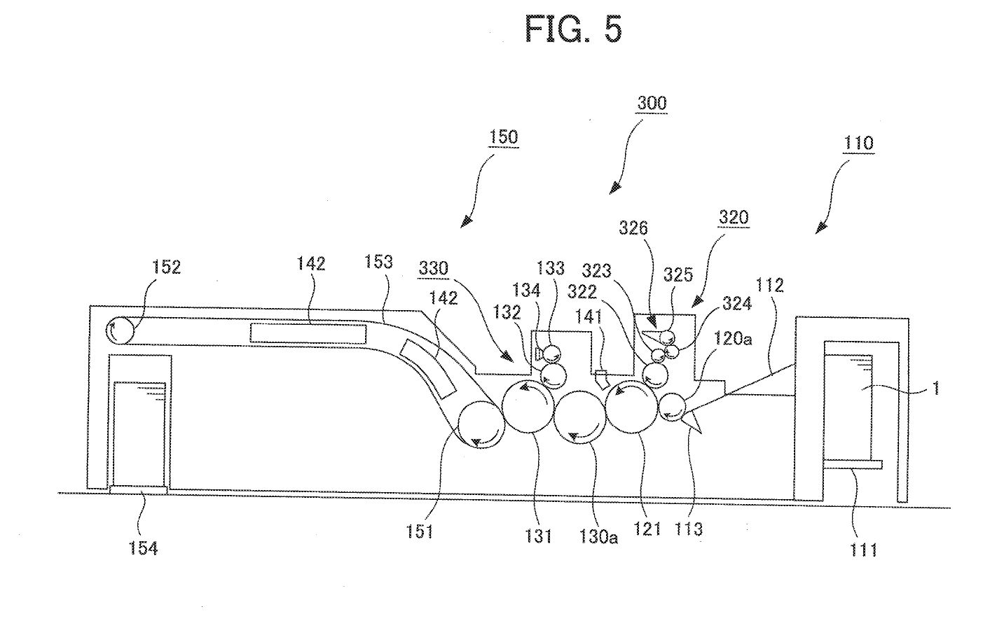

Based on FIGS. 5 to 8, description is provided for a third embodiment in which a liquid transfer device according to the present invention is applied to a coater. Here, description duplicating the description of the foregoing embodiments is omitted with the same components as those in the foregoing embodiments assigned with the same reference signs as those used in the description of the foregoing embodiments.

As illustrated in FIG. 5, a first impression cylinder 121 of a first coating unit 320 is in contact with the transfer cylinder 120a.

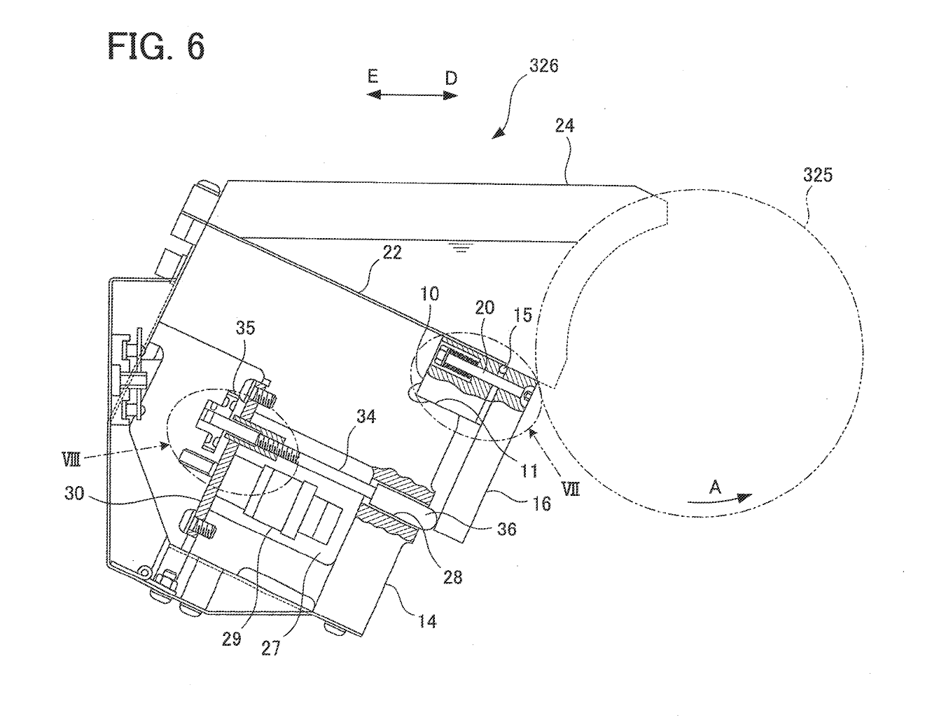

A plate cylinder 322 is in contact with the first impression cylinder 121 at a position located above the axial center position of the first impression cylinder 121 and downstream in the rotation direction (downstream in the carrying direction of the sheet 1) of the contact position of the first impression cylinder 121 with the transfer cylinder 120a, i.e., the reception position at which the first impression cylinder 121 receives a sheet 1 from the transfer cylinder 120a. A plate (coater plate) is attached to an outer circumferential surface of the plate cylinder 322. A form roller 323 configured to supply a transparent ink to the plate cylinder 322 is in contact with the plate cylinder 322. An oscillating roller 324 capable of reciprocating in its axial direction is in contact with the form roller 323. A fountain roller 325 configured to pick up a transparent ink from inside of an ink fountain 326 is in contact with the oscillating roller 324. Here, the transparent inks is a first liquid and has high viscosity. The ink fountain 326 has a structure illustrated in FIGS. 6 to 8 as disclosed in Patent Literature 2 listed above.

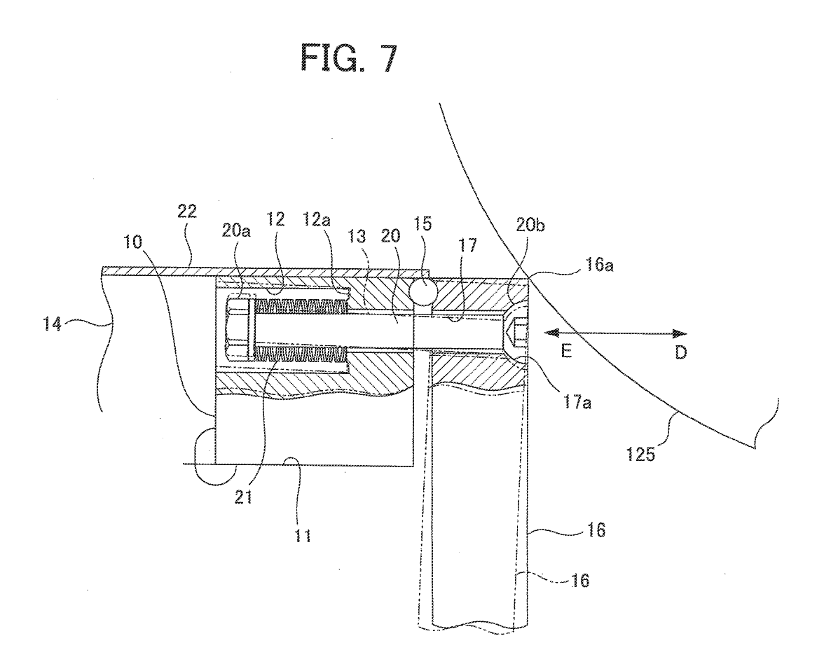

In FIG. 6, reference sign 10 is a holder bar attached to a groove 11 provided at an upper front end portion of a fountain key support 14 in such a manner that the holder bar 10 extends in an axial direction of the fountain roller 325, and is formed with a length substantially equal to a cylinder length of the fountain roller 325. In this holder bar 10, a large-diameter hole 12 and a small-diameter hole 13 communicating with the large-diameter hole 12 are formed so as to pass through the holder bar 10 in a front-back direction as illustrated in FIG. 7. Multiple pairs of the large-diameter holes 12 and small-diameter holes 13 corresponding to multiple ink fountain keys 16 to be described later are provided along the axial direction of the fountain roller 325.

Reference sign 15 denotes a long slender support pin formed in a substantially cylindrical shape with a length substantially equal to the length of the holder bar 10. Reference sign 16 denotes an ink fountain key formed in a rectangular pillar shape. Multiple ink fountain keys 16 are arranged along the axial direction of the fountain roller 325 while being located close to a circumferential surface of the fountain roller 325. These multiple ink fountain keys 16 are formed to have a total width-wise length equal to the aforementioned cylinder length of the fountain roller 325. The ink fountain keys 16 are each provided with a through hole 17 having a diameter equal to the diameter of the small-diameter hole 13 of the holder bar 10 described above. As illustrated in FIG. 7, a recessed portion 17a formed in a substantially hemispherical shape is provided to one of opening edges of the through hole 17.

Reference sign 20 denotes a fountain key opening pin loosely inserted in the small-diameter hole 13 of the holder bar 10 and in the through hole 17 of the ink fountain key 16. In the fountain key opening pin 20, one of end portions is provided with a head portion 20a, and the other end portion is provided with an expanded portion 20b formed in a substantially hemispherical shape to be engaged with the recessed portion 17a of the ink fountain key 16. Reference sign 21 denotes disc springs inserted in a compressed state between the head portion 20a of the fountain key opening pin 20 and a bottom portion 12a of the large-diameter portion 12 of the holder bar 10. The ink fountain key 16 is held by the holder bar 10 via the support pin 15 resiliently and swingably with a resilient force of the disc springs 21. In this state, with the resilient force of the disc springs 21, the fountain key opening pin 20 energizes the ink fountain key 16 in a direction in which the ink fountain key 16 is moved away from the circumferential surface of the fountain roller 125, i.e., in a clockwise direction in the drawings by using the support pin 15 as a rotation center.

In FIG. 6, reference sign 22 denotes a bottom plate fixed to an upper surface of the fountain key support 14 and forming a bottom surface of the ink fountain together with upper surfaces of the ink fountain keys 16. Reference sign 24 denotes an ink weir formed in a triangular shape in a side view. The ink weirs 24 are provided to stand and face each other at both widthwise end portions (an illustration of one of the end portions is omitted) of the fountain key support 14. The transparent ink is stored in the ink fountain 126 surrounded by the ink weirs 24, the bottom plate 22, the ink fountain keys 16, and the circumferential surface of the fountain roller 125.

As illustrated in FIG. 6, a recessed portion 27 is provided to a lower portion of the fountain key support 14. The recessed portion 27 has an opening on a back side of the fountain key support 14, and extends between both the end portions of the fountain key support 14. Multiple through holes 28 communicating with the recessed portion 27 and passing through a front end portion of the fountain key support 14 are provided corresponding to the aforementioned multiple ink fountain keys 16. Reference sign 29 denotes multiple motors housed in the recessed portion 27 and provided corresponding to the multiple ink fountain keys 16. The motors 29 are supported by a support plate 30 attached to an opening edge of the recessed portion 27.

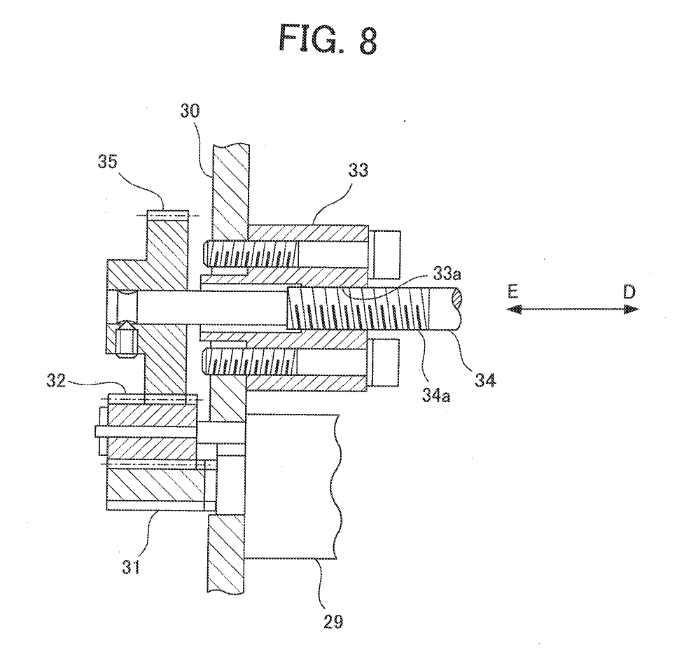

As illustrated in FIG. 8, a motor gear 31 is fixed to an output shaft of each of the motors 29 in a manner rotatable together, and a transmission gear 32 meshes with the motor gear 31. Reference sign 33 is a screw rod support block attached to the support plate 30 and having thread holes 33a at a center portion thereof. Reference sign 34 denotes multiple fountain key open/close screw rods provided corresponding to the ink fountain keys 16. Each of the fountain key open/close screw rods 34 is provided with a thread portion 34a at a center portion thereof, and the thread portion 34a mates with the thread portion 33a of the screw rod support block 33. A gear 35 meshing with the transmission gear 32 is fixed to one end portion of the fountain key open/close screw rod 34 protruding from the support plate 30, in a manner rotatable together. Meanwhile, a pressing member 36 is provided to the other end portion of the fountain key open/close screw rod 34. The pressing member 36 is inserted into the through hole 28 of the fountain key support 14, and a tip end of the pressing member 36 is in contact with a lower end portion of the ink fountain key 16 as illustrated in FIG. 6.

In this structure, when the motor 29 is driven in one direction, the rotation of the output shaft of the motor 29 is transmitted from the motor gear 31 to the gear 35 via the transmission gear 32, and the gear 35 rotates in the clockwise direction in FIG. 6. With the rotation of the gear 35 in the clockwise direction, the fountain key open/close screw rod 34 having the thread portion 34a mating with the thread hole 33a of the screw rod support block 33 moves in an arrow D direction in FIG. 7, and accordingly the pressing member 36 moves forward from the through hole 28. With this forward movement of the pressing member 36, the ink fountain key 16 swings in an anticlockwise direction against the resilient force of the disc springs 21 with the support pin 15 used as a hinged support as illustrated by a solid line in FIG. 7. Consequently, a gap between the circumferential surface of the fountain roller 325 and a corner portion 16a of the ink fountain key 16, in other words, an opening between the circumferential surface of the fountain roller 125 and the bottom plate 22 is narrowed, so that an amount of the transparent ink picked up from the ink fountain 326 is adjusted to a decreased amount.

On the other hand, when the motor 29 is driven in another direction which is an opposite direction to the one direction, the rotation of the output shaft of the motor 29 is transmitted from the motor gear 31 to the gear 35 via the transmission gear 32, and the gear 35 rotates in the anticlockwise direction in FIG. 6. With the rotation of the gear 35 in the anticlockwise direction, the fountain key open/close screw rod 34 having the thread portion 34a mating with the thread hole 33a of the screw rod support block 33 moves in an arrow E direction in FIG. 8, and accordingly the pressing member 36 retreats to the inside of the through hole 28. With this retreat of the pressing member 36, the ink fountain key 16 swings in the clockwise direction due to the resilient force of the disc springs 21 with the support pin 15 used as the hinged support as illustrated by a chain double-dashed line in FIG. 7. Consequently, the gap between the circumferential surface of the fountain roller 325 and the corner portion 16a of the ink fountain key 16, in other words, the opening between the circumferential surface of the fountain roller 325 and the bottom plate 22 is widened, so that the amount of the transparent ink picked up from the ink fountain 326 is adjusted to an increased amount.

Next, description is provided for a coater 300 according to the present embodiment configured as described above.

As is the case with the foregoing embodiments, sheets 1 on the paper feed tray 111 are fed one by one by the paper feeder 110. Each of the sheets 1 is transferred to the first impression cylinder 121 of the first coating unit 320 via the feeder board 112, the swing device 113, and the transfer cylinder 120a. Thus, the sheet 1 is carried and held by the first impression cylinder 121 with one side of the sheet 1 facing outside, and the one side of the sheet 1 is pressed against the plate cylinder 322. Meanwhile, the transparent ink picked up from the inside of the ink fountain 326 by the fountain roller 325 is transferred to the form roller 323 while being evenly spread out in the axial direction by the oscillating roller 324, and then is supplied to the plate (coater plate) of the plate cylinder 322. Thus, a spot coating of the transparent ink is applied to the one side of the sheet 1 at predetermined areas corresponding to an image pattern of the plate (coater plate). Then, the applied transparent ink is dried (cured) by the first dryer 141.

Thereafter, the sheet 1 is transferred from the first impression cylinder 121 of the first coating unit 320 via the transfer cylinder 130a to the second impression cylinder 131 of the second coating unit 330 in such a manner that the opposite side of the sheet 1 comes into contact with the second impression cylinder 131. Thus, while the sheet 1 is being carried and held with the one side thereof facing outside, the spot-coating of transparent ink applied on the one side is further coated so as to be covered with a varnish as a second liquid, as similar to the foregoing embodiments.

On the sheet 1 processed by the coater 300 as described above, the transparent ink is transferred to the one side to form tactile raised parts 2 on the one side, and the varnish is transferred to the one side to form a coating part 3 which covers the raised parts 2 while maintaining shapes of the raised parts 2, as in the foregoing embodiments.

In short, the coaters 100, 200 according to the foregoing embodiments transfers the first varnish to the one side of the sheet 1 so as to form the tactile raised parts 2 on the one side of the sheet 1 in such a way that the rotary screen cylinder 122 spot-coats only some areas of the one side of the sheet 1. In contrast, in the coater 300 according to the present embodiment transfers the transparent ink to the one side of the sheet 1 so as to form the tactile raised parts 2 on the one side of the sheet 1 in such a way that the transparent ink with high viscosity picked up from the inside of the ink fountain 326 of the first coating unit 320 by the fountain roller 325 is applied as a spot-coating to only some areas of the one side of the sheet 1 only by way of the oscillating roller 324, the form roller 323, and the plate cylinder 322.

Thus, in the coater 300 according to the present embodiment, a delivery route of the transparent ink from the inside of the ink fountain 326 to the sheet 1, i.e., the number of times of transfer between the rollers is kept to the minimum necessary. This allows a film formed of the transparent ink to be subjected only to the minimum necessary thickness reduction in the route from the fountain roller 325 to the spot coating on the sheet 1. Thus, the transparent ink can be applied as a thick spot-coating layer on the sheet 1 to form the raised parts 2, and therefore an adequately tactile coating can be easily applied to the sheet 1.

Hence, according to the present embodiment, it is possible to obtain the same effects as those described in the foregoing embodiments.

Further, the ink fountain 326 of the first coating unit 120 includes transparent ink pickup amount adjustment means in which the motor 29 is operated to adjust the size of the opening between the circumferential surface of the fountain roller 325 and the bottom plate 22, and thereby to adjust an amount of a transparent ink picked up. Thus, the thickness of the transparent ink to be applied as a spot-coating to a predetermined area on one side of the sheet 1 can be adjusted easily.

### Fourth Embodiment

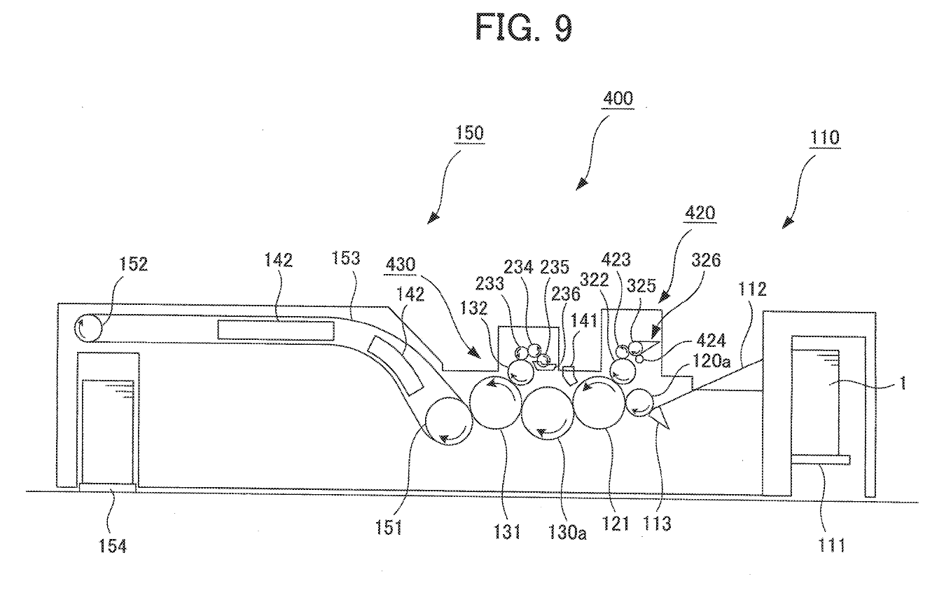

Based on FIG. 9, description is provided for a fourth embodiment in which a liquid transfer device according to the present invention is applied to a coater. Here, description duplicating the description of the foregoing embodiments is omitted with the same components as those in the foregoing embodiments assigned with the same reference signs as those used in the description of the foregoing embodiments.

As illustrated in FIG. 9, a form roller 423 configured to supply a transparent ink to the plate cylinder 322 is in contact with the plate cylinder 322. The fountain roller 325 configured to pick up the transparent ink with high viscosity from the inside of the ink fountain 326 is in contact with the form roller 423. An oscillating roller 424 capable of reciprocating in its axial direction is in contact with the fountain roller 325 at a position upstream in a rotation direction of the contact position of the fountain roller 325 with the form roller 423.

In other words, a first coating unit 420 of a coater 400 according to the present embodiment is configured such that the oscillating roller 424 is not in contact with the form roller 423, but is only in contact with the fountain roller 325, and the form roller 423 is in contact with the fountain roller 325 without the oscillating roller 424 interposed in between.

Hence, according to the present embodiment, it is possible to obtain the same effects as those described in the foregoing embodiments.

### Fifth Embodiment

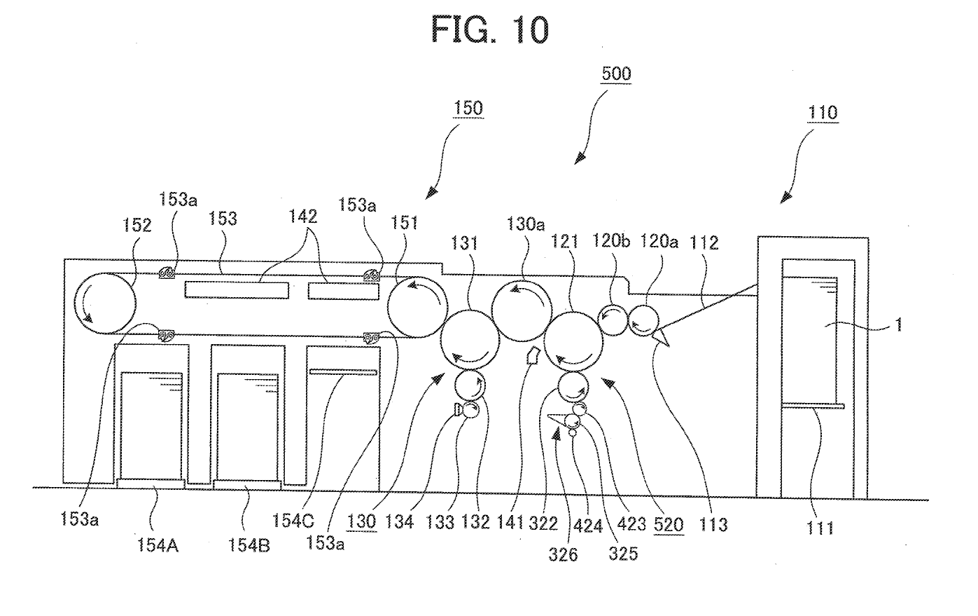

Based on FIG. 10, description is provided for a fifth embodiment in which a liquid transfer device according to the present invention is applied to a coater. Here, description duplicating the description of the foregoing embodiments is omitted with the same components as those in the foregoing embodiments assigned with the same reference signs as those used in the description of the foregoing embodiments.

As illustrated in FIG. 10, a first impression cylinder 121 of a first coating unit 520 is in contact with the transfer cylinder 120a via the transfer cylinder 120b configured to hold and carry the sheet 1. The plate cylinder 322 is in contact with the first impression cylinder 121 at a position below the axial center position of the first impression cylinder 121 and downstream in a rotation direction (downstream in the carrying direction of the sheet 1) of the contact position of the first impression cylinder 121 with the transfer cylinder 120b, i.e., a reception position at which the first impression cylinder 121 receives the sheet 1 from the transfer cylinder 120b. The form roller 423 is in contact with the plate cylinder 322. The fountain roller 325 is in contact with the form roller 423. Then, the oscillating roller 424 is in contact with the fountain roller 325 at a position upstream in a rotation direction of the contact position of the fountain roller 325 with the form roller 423.

In other words, in a coater 500 according to the present embodiment, the first coating unit 520 is configured such that the plate cylinder 322, the form roller 423, the oscillating roller 424, the fountain roller 325, and the ink fountain 326 are located below the axial center position of the first impression cylinder 121.

Hence, the coater 500 according to the present embodiment can produce the same effects as those in the coater 100 according to the foregoing embodiment as a matter of course, and further can achieve the following effects. Specifically, various kinds of work, such as manipulation work, cleaning work, component replacement work, and maintenance, for the plate cylinder 322, the form roller 423, the oscillating roller 424, the fountain roller 325, and the ink fountain 326 can be performed from the lower side (the installation floor side). This makes it easier to carry out the work, and thereby enables reduction in a burden of an operator. Further, since a space between the installation floor and the impression cylinder 121 as well as the transfer cylinder 130a is also widened, a sufficiently-large working space can be reserved below the impression cylinder 121 and the transfer cylinder 130a, so that an operator can easily perform work such as removal of a sheet 1 or a fragment of a sheet 1.

### Sixth Embodiment

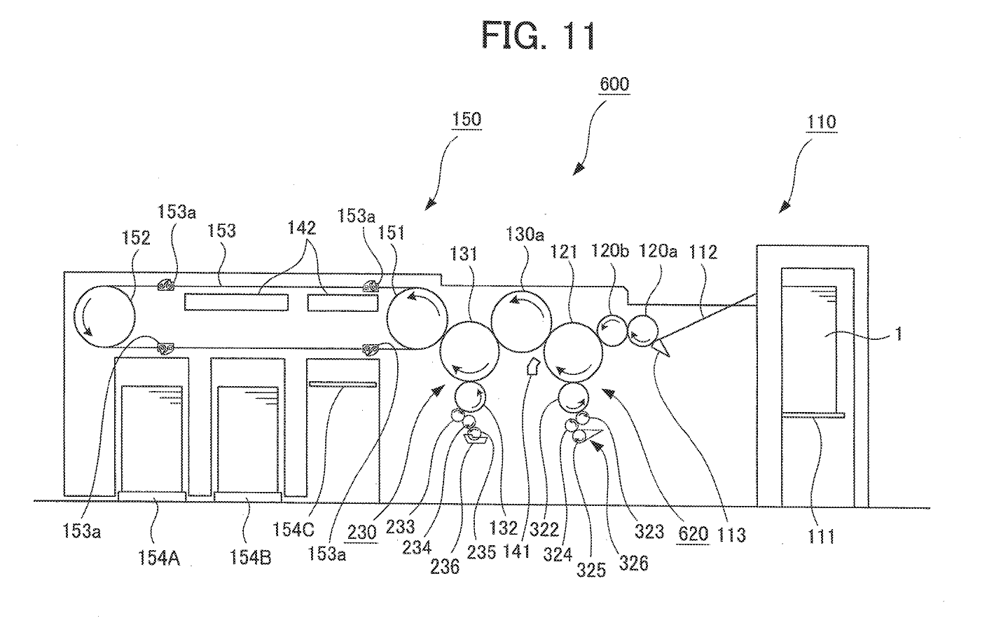

Based on FIG. 11, description is provided for a sixth embodiment in which a liquid transfer device according to the present invention is applied to a coater. Here, description duplicating the description of the foregoing embodiments is omitted with the same components as those in the foregoing embodiments assigned with the same reference signs as those used in the description of the foregoing embodiments.

As illustrated in FIG. 11, the form roller 323 is in contact with the plate cylinder 322. The oscillating roller 324 is in contact with the form roller 323. The fountain roller 325 is in contact with the oscillating roller 324.

In other words, in a coater 600 according to the present embodiment, a first coating unit 620 is configured such that the plate cylinder 322, the form roller 323, the oscillating roller 324, the fountain roller 325, and the ink fountain 326 are located below the axial center position of the first impression cylinder 121, the oscillating roller 324 is in contact with not only the fountain roller 325 but also the form roller 323, and the form roller 323 is in indirect contact with the fountain roller 325 with the oscillating roller 324 interposed in between.

Thus, according to the present embodiment, it is possible to obtain the same effects as those described in the foregoing embodiments.

### Other Embodiments

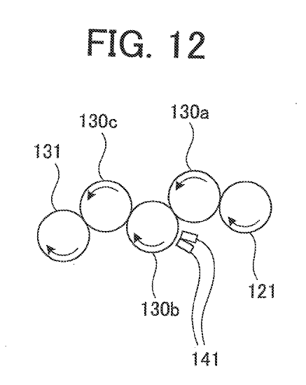

In the foregoing embodiments, the first impression cylinder 121 and the second impression cylinder 131 are connected to each other via the intermediate sheet carrying means including the single transfer cylinder 130a. Instead, in another embodiment, as illustrated in FIG. 12, for example, the first impression cylinder 121 and the second impression cylinder 131 may be connected to each other via intermediate sheet carrying means including three transfer cylinders 130a to 130c. In this structure, the one side of the sheet 1 on which the raised parts 2 are formed by the spot-coating of the first liquid can be made to face outside on the transfer cylinder 130b. Since two or more first dryers 141 can be arranged easily in a space around the transfer cylinder 130b, the spot-coating of the first liquid forming the raised parts 2 on the one side of the sheet 1 can be efficiently dried (cured).

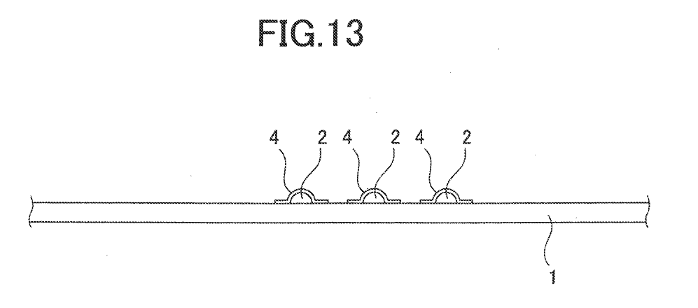

Moreover, in the foregoing embodiments, the rubber blanket is wound around the coater cylinder 132 in each of the second coating units 130, 230, 330, 430, and forms the coating part 3 by applying the second liquid over the entire area of the one side of the sheet 1 so as to cover the raised parts 2 spot-coated with the first liquid on the one side of the sheet 1. However, the present invention is not limited to this. It is only necessary to form a coating part by coating a sheet with a second liquid such that the coating part can prevent a raised part from dropping off from the sheet without impairing the tactile effect of the raised part. For example, in another embodiment, a relief printing plate may be wound around the coater cylinder 132 of any of the second coating units 130, 230, 330, 430. In this case, as illustrated in FIG. 13, it is possible to form coating parts 4 by coating only areas on and around the raised parts 2 on the one side of the sheet 1 with the second liquid so as to cover the raised parts 2 spot-coated with the first liquid on the one side of the sheet 1.

Incidentally, a first liquid such as a transparent ink may have a liquid-repellent property with a lower surface tension than that of a second liquid such as a varnish, for example. In this case, due to a difference in surface tension between the first liquid and the second liquid, a raised part 2 spot-coated with the first liquid repels the second liquid. As a result, only an area of the coating with the second liquid applied on the raised part 2 has a surface with fine asperities, while the other area of the coating with the second liquid outside the raised part 2 has a flat and smooth surface.

Thus, in the coating with the second liquid, the raised part 2 (the part located on the coating with the first liquid) has the rough surface, which produces a tactile effect with a “sandy” texture, while the other part outside the raised part 2 has a smooth surface, which produces a tactile effect with a “slippery” texture. This difference between the tactile effects may enhance the easiness of identification of the sheet 1.

In addition, a coating with a varnish as the second liquid has a mat surface in a part (raised part 2) on the coating with the transparent ink as the first liquid, and has a glossy surface in the other part. Thus, designing may be made by additionally using such a difference in gloss, and resultantly may provide a coating with a higher added value.

Moreover, the present invention is not limited to the coaters 100, 200, 300, 400, 500, 600 according to the foregoing embodiments, but a coater including any combination of the first coating units 120, 320, 420, 520, 620 and the second coating units 130, 230, 330, 430 as needed can produce the same effects as those in the foregoing embodiments.

In addition, the foregoing embodiments have been described for the case where a coating is applied to a sheet 1. However, the present invention is not limited to this. For example, also in a case where a liquid is transferred to a strip-shaped web, the present invention can produce the same effects as those in the foregoing embodiments.

### INDUSTRIAL APPLICABILITY

A liquid transfer device according to the present invention is capable of spot coating a substrate with a thick layer, and therefore is very advantageously usable in, for example, printing industries and other industries.

### REFERENCE SIGNS LIST

1 sheet
2 raised part
3, 4 coating part
100 coater
110 paper feeder
111 paper feed tray
112 feeder board
113 swing device
120 first coating unit
120a to 120d transfer cylinder
121 first impression cylinder
122 rotary screen cylinder
130 second coating unit
130a transfer cylinder
131 second impression cylinder
132 coater cylinder
133 anilox roller
134 chamber
141 first dryer
142 second dryer
150 delivery device
151 delivery cylinder
152 sprocket
153 delivery chain
153a claw hook
154, 154A to 154C delivery tray
200 coater
230 second coating unit
233 form roller
234 metering roller
235 dampening roller
236 varnish pan
300 coater
320 first coating unit
322 plate cylinder
323 form roller
324 oscillating roller
325 fountain roller
326 ink fountain
330 second coating unit
400 coater
420 first coating unit
423 form roller
424 oscillating roller
430 second coating unit
500 coater
520 first coating unit
600 coater
620 first coating unit

1. A liquid transfer device comprising:
first liquid transfer means configured to transfer a first liquid to one side of a substrate in such a manner that the first liquid forms a tactile raised part on the one side of the substrate; and
second liquid transfer means provided downstream of the first liquid transfer means in a substrate carrying direction, and configured to transfer a second liquid to the one side of the substrate in such a manner that the second liquid covers the raised part while maintaining a shape of the raised part on the one side of the substrate.

2. The liquid transfer device according to claim 1, wherein
the first liquid transfer means is a first coating unit including
a first support cylinder configured to hold and carry the substrate, and
a rotary screen cylinder provided in contact with the first support cylinder, and configured to coat the one side of the substrate with the first liquid while the substrate is passing between the first support cylinder and the rotary screen cylinder, and
the second liquid transfer means is a second coating unit including
a second support cylinder configured to hold and carry the substrate in such a manner as to bring an outer circumferential surface of the second support cylinder into contact with an opposite side of the substrate,
a coater cylinder provided in contact with the second support cylinder, and
coater cylinder liquid supply means configured to supply the second liquid to the coater cylinder,
the second coating unit configured to coat the one side of the substrate with the second liquid.

3. The liquid transfer device according to claim 2, wherein
the substrate is a sheet,
the first support cylinder of the first coating unit is a first impression cylinder configured to hold and carry the sheet,
the second support cylinder of the second coating unit is a second impression cylinder configured to hold and carry the sheet,
the liquid transfer device further comprises:
upstream sheet carrying means provided upstream of the first impression cylinder of the first coating unit in a sheet carrying direction, and configured to carry the sheet to the first impression cylinder;
intermediate sheet carrying means provided downstream of the first impression cylinder of the first coating unit in the sheet carrying direction, and upstream of the second impression cylinder of the second coating unit in the sheet carrying direction, and configured to carry the sheet received from the first impression cylinder to the second impression cylinder; and
downstream sheet carrying means provided downstream of the second impression cylinder of the second coating unit in the sheet carrying direction, and configured to carry the sheet received from the second impression cylinder,
the rotary screen cylinder of the first coating unit is in contact with the first impression cylinder between a reception position at which the first impression cylinder receives the sheet from the upstream sheet carrying means, and a transfer position at which the first impression cylinder transfers the sheet to the intermediate sheet carrying means, and
the coater cylinder of the second coating unit is in contact with the second impression cylinder at a position below an axial center position of the second impression cylinder and between a reception position at which the second impression cylinder receives the sheet from the intermediate sheet carrying means and a transfer position at which the second impression cylinder transfers the sheet to the downstream sheet carrying means.

4. The liquid transfer device according to claim 2, wherein,
the coater cylinder liquid supply means of the second coating unit includes
an anilox roller provided in contact with the coater cylinder, and
a chamber configured to supply the second liquid to the anilox roller.

5. The liquid transfer device according to claim 2 wherein,
the coater cylinder liquid supply means of the second coating unit includes
a liquid pool in which the second liquid is stored, a form roller provided in contact with the coater cylinder,
a metering roller provided in contact with the form roller, and
a dampening roller provided in contact with the metering roller and configured to pick up the second liquid inside the liquid pool.

6. The liquid transfer device according to claim 1, wherein
the first liquid is a transparent ink,
the second liquid is a varnish,
the first liquid transfer means is a first coating unit including
an ink fountain in which the transparent ink is stored,
a fountain roller configured to pick up the transparent ink inside the ink fountain,
an oscillating roller provided in contact with the fountain roller,
a form roller provided in contact with the fountain roller or the oscillating roller,
a plate cylinder provided in contact with the form roller, and
a first support cylinder provided in contact with the plate cylinder, and configured to hold and carry the substrate,
the first coating unit configured to coat the one side of the substrate with the transparent ink, and
the second liquid transfer means is a second coating unit including
a second support cylinder configured to hold and carry the substrate in such a manner as to be in contact with an opposite side of the substrate,
a coater cylinder provided in contact with the second support cylinder, and
varnish supply means configured to supply the varnish to the coater cylinder, the second coating unit configured to coat the one side of the substrate with the varnish.

7. The liquid transfer device according to claim 6, wherein
the plate cylinder of the first coating unit is in contact with the first support cylinder at a position below an axial center position of the first support cylinder, and
the coater cylinder of the second coating unit is in contact with the second support cylinder at a position below an axial center position of the second support cylinder.

8. The liquid transfer device according to claim 7, wherein
the substrate is a sheet,
the first support cylinder of the first coating unit is a first impression cylinder configured to hold and carry the sheet,
the second support cylinder of the second coating unit is a second impression cylinder configured to hold and carry the sheet,
the liquid transfer device comprises:
upstream sheet carrying means provided upstream of the first impression cylinder of the first coating unit in a sheet carrying direction, and configured to carry the sheet to the first impression cylinder;
intermediate sheet carrying means provided downstream of the first impression cylinder of the first coating unit in the sheet carrying direction and upstream of the second impression cylinder of the second coating unit in the sheet carrying direction, and configured to carry the sheet received from the first impression cylinder to the second impression cylinder; and
downstream sheet carrying means provided downstream of the second impression cylinder of the second coating unit in the sheet carrying direction, and configured to carry the sheet received from the second impression cylinder,
the plate cylinder of the first coating unit is in contact with the first impression cylinder between a reception position at which the first impression cylinder receives the sheet from the upstream sheet carrying means, and a transfer position at which the first impression cylinder transfers the sheet to the intermediate sheet carrying means, and
the coater cylinder of the second coating unit is in contact with the second impression cylinder between a reception position at which the second impression cylinder receives the sheet from the intermediate sheet carrying means, and a transfer position at which the second impression cylinder transfers the sheet to the downstream sheet carrying means.

9. The liquid transfer device according to claim 8, wherein
the downstream sheet carrying means includes
an endless chain arranged in such a circular manner as to circularly run between a reception position at which the endless chain receives the sheet from the second impression cylinder of the second coating unit and a distant position at which the endless chain is located away from the second impression cylinder, the endless chain directed in such a manner as to run on an upper side from the reception position to the distant position, and to run on a lower side from the distant position to the reception position; and
a claw hook attached to the endless chain in such a manner as to move along with running of the endless chain, and configured to receive and hold the sheet from the second impression cylinder of the second coating unit, and
the liquid transfer device comprises:
varnish drying means configured to dry the varnish on the one side of the sheet held by the claw hook which is running and moving on the upper side of the endless chain; and
sheet stacking means provided below the endless chain and configured to stack the sheet released from the claw hook.

10. The liquid transfer device according to claim 6 wherein
the varnish supply means of the second coating unit includes
an anilox roller provided in contact with the coater cylinder, and
a chamber configured to supply the varnish to the anilox roller.

11. The liquid transfer device according to claim 6, wherein
the varnish supply means of the second coating unit includes
a liquid pool in which the varnish is stored,
a form roller provided in contact with the coater cylinder,
a metering roller provided in contact with the form roller, and
a dampening roller provided in contact with the metering roller and configured to pick up the varnish inside the liquid pool.

12. A liquid transfer method comprising:
transferring a first liquid to one side of a substrate in such a manner that the first liquid forms a tactile raised part on the one side of the substrate; and
thereafter transferring a second liquid to the one side of the substrate in such a manner that the second liquid covers the raised part while maintaining a shape of the raised part on the one side of the substrate.

13. A substrate comprising:
a tactile raised part formed on one side of the substrate by transferring a first liquid to the one side; and
a coating part formed on the one side by transferring a second liquid to the one side in such a manner that the second liquid covers the raised part while maintaining a shape of the raised part.
